(19) United States
(12) Patent Application Publication
(10) Pub. No.: US 2015/0085754 A1
(43) Pub. Date: Mar. 26, 2015

(54) METHODS AND APPARATUS FOR ENHANCED FREQUENCY MEASUREMENTS

(71) Applicant: QUALCOMM Incorporated, San Diego, CA (US)

(72) Inventors: Jin-Sheng SU, San Diego, CA (US); Yu Fu, San Diego, CA (US); Tom Chin, San Diego, CA (US)

(73) Assignee: QUALCOMM Incorporated, San Diego, CA (US)

(21) Appl. No.: 14/032,896

(22) Filed: Sep. 20, 2013

(51) Int. Cl. H04W 72/04

(52) U.S. Cl. CPC H04W 72/0446
USPC 370/329

(57) ABSTRACT

Methods and apparatus for wireless communication comprise receiving a measurement configuration message indicating a Dedicated Channel (DCH) measurement occasion (DMO) gap for inter-radio access technology (IRAT) measurements of a first technology type during operation of the UE according to a second technology type. The methods and apparatus further comprise determining an adjusted DMO gap based on at least one DMO gap adjustment rule, wherein the adjusted DMO gap is shorter in duration than the DMO gap. Moreover, the methods and apparatus comprise performing a frequency measurement for the second technology type during the DMO gap in one or more open time slots made available by the adjusted DMO gap.

### BACKGROUND

1. Field

Aspects of the present disclosure relate generally to wireless communication systems, and more particularly, to enhanced frequency measurements.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, under-utilization and/or inefficient allocation of available communication resources, particularly frequency measurements, may often lead to degradations in wireless communication. Even more, the foregoing resource under-utilization and/or inefficiencies inhibit user equipments and other network devices from achieving higher wireless communication quality. Thus, improvements in frequency measurements are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method of operating a user equipment (UE) for wireless communication comprises receiving a measurement configuration message indicating a Dedicated Channel (DCH) measurement occasion (DMO) gap for inter-radio access technology (IRAT) measurements of a first technology type during operation of the UE according to a second technology type. The method further comprises determining an adjusted DMO gap based on at least one DMO gap adjustment rule, wherein the adjusted DMO gap is shorter in duration than the DMO gap. Moreover, the method comprises performing a frequency measurement for the second technology type during the DMO gap in one or more open time slots made available by the adjusted DMO gap.

In another aspect, a computer program product for wireless communication comprising a computer-readable medium includes at least one instruction for causing a computer to receive a measurement configuration message indicating a Dedicated Channel (DCH) measurement occasion (DMO) gap for inter-radio access technology (IRAT) measurements of a first technology type during operation of a user equipment (UE) according to a second technology type. The computer-readable medium further includes at least one instruction for causing a computer to determine an adjusted DMO gap based on at least one DMO gap adjustment rule, wherein the adjusted DMO gap is shorter in duration than the DMO gap. Moreover, the computer-readable medium includes at least one instruction for causing a computer to perform a frequency measurement for the second technology type during the DMO gap in one or more open time slots made available by the adjusted DMO gap.

Further aspects include an apparatus for wireless communication comprising means for receiving a measurement configuration message indicating a Dedicated Channel (DCH) measurement occasion (DMO) gap for inter-radio access technology (IRAT) measurements of a first technology type during operation of a user equipment (UE) according to a second technology type. The apparatus further comprises means for determining an adjusted DMO gap based on at least one DMO gap adjustment rule, wherein the adjusted DMO gap is shorter in duration than the DMO gap. Moreover, the apparatus comprises means for performing a frequency measurement for the second technology type during the DMO gap in one or more open time slots made available by the adjusted DMO gap.

Additional aspects include a user equipment (UE) apparatus for wireless communication comprising a memory storing executable instructions and a processor in communication with the memory, wherein the processor is configured to execute the instructions to receive a measurement configuration message indicating a Dedicated Channel (DCH) measurement occasion (DMO) gap for inter-radio access technology (IRAT) measurements of a first technology type during operation of the UE according to a second technology type. The processor is further configured to execute the instructions to determine an adjusted DMO gap based on at least one DMO gap adjustment rule, wherein the adjusted DMO gap is shorter in duration than the DMO gap. Moreover, the processor is configured to execute the instructions to perform a frequency measurement for the second technology type during the DMO gap in one or more open time slots made available by the adjusted DMO gap.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a user equipment that may enhance frequency measurements;

FIG. 2 is a schematic diagram of an aspect of the DMO gap adjustment component of FIG. 1;

FIG. 3a is a conceptual diagram of an example single frame DMO gap;

FIG. 3b is a conceptual diagram of an example adjusted DMO gap, e.g., according to FIG. 1;

FIG. 4a is a conceptual diagram of an example two frame DMO gap;

FIG. 4b is a conceptual diagram of an example adjusted DMO gap, according to FIG. 1;

FIG. 5 is a flowchart of an aspect of the DMO gap adjustment features at a user equipment, according to FIG. 1;

FIG. 6 is a block diagram conceptually illustrating an example of a wireless communication system including an aspect of the user equipment described herein;

FIG. 7 is a block diagram conceptually illustrating an example of a frame structure in a wireless communication system including an aspect of the user equipment described herein; and

FIG. 8 is a block diagram conceptually illustrating an example of a Node B in communication with a UE in a telecommunications system, where the user equipment may be the same as or similar to the user equipment described herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present aspects generally relate to enhancements in frequency measurements. Specifically, in some communication technology types (e.g., time division technologies such as TD-SCDMA), particular time slots may be designated with certain predefined communication characteristics. For example, in time division technology, TS0 and/or Special slots may generally be utilized to obtain inter/intra frequency measurements at every occurrence within a frame and/or subframe. That is, a user equipment (UE) may obtain inter/intra frequency measurements at every TS0 and/or Special time slot occurrence to facilitate, for example, cell reselection and/or handover. However, in some non-limiting cases, measurements on TS0 may be limited by the network to a particular technology type (e.g., LTE), which may be different from the current operating technology (e.g., TD-SCDMA) of the UE, thereby resulting in excessive inter/intra frequency measurements for the network designated particular technology type.

For example, a UE may be configured by the network with an idle interval or DCH measurement occasion (DMO) gap, during TD-SCDMA connected mode operation, to perform inter-radio access technology (IRAT) measurements, e.g., to switch over to make LTE measurements. During the idle interval or DMO gap, however, the UE cannot perform measurements in its currently operating technology or any other technology (e.g., when operating in TD-SCDMA, the UE cannot perform TD-SCDMA (home RAT) or GSM (IRAT) measurements during an LTE DMO gap). As such, as a result of the configured idle interval or DMO gap for performing LTE measurements, the UE may fail to utilize opportunities for making frequency measurements, which can lead to call failures, for example, during handover scenarios. However, the entire idle interval or DMO gap may not be necessary for conducting IRAT measurements of the network identified technology type (e.g., LTE).

Accordingly, according to aspects of the present apparatus and methods, an adjustment of DMO gap may be made to provide efficient frequency measurement allocation. Accordingly, in some aspects, the present methods and apparatuses may provide an efficient solution, as compared to current solutions, to enhance handover/reselection by efficiently allocating frequency measurements for each time slot of a DMO gap.

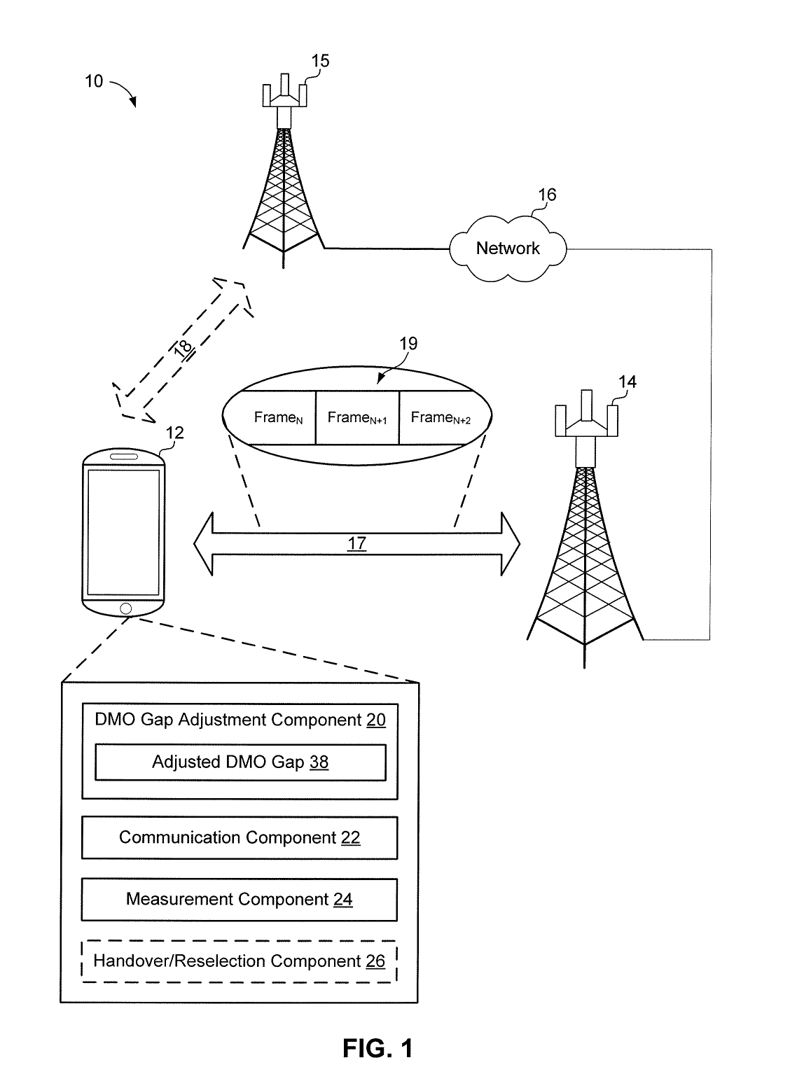

Referring to FIG. 1, in one aspect, a wireless communication system 10 includes at least one UE 12 in communication coverage of first network entity 14 (e.g., base station). UE 12 may communicate with network 16 by way of, for instance, first network entity 14. In some aspects, UE 12 may also be in communication coverage of second network entity 15, which may be a suitable handover/reselection candidate. Further, UE 12 may communicate with first network entity 14 and second network entity 15 via one or more communication channels 17 and 18, respectively, utilizing one or more RATs (e.g., TD-SCDMA). In such aspects, the one or more communication channels 17 and 18 may enable communication on both the uplink and downlink. Moreover, for instance, communication using the one or more communication channels 17 and 18 may be conducted by way of a time division technology (e.g., arranged in one or more frames 19). For instance, each frame of frames 19 (e.g., Frame_{N}) may include one or more time slots each capable of communicating measurement and/or data along one or more communication channels (e.g., communication channel 18).

As a non-limiting example, UE 12 may utilize time slot 0 (TS0) and/or Special (“S”) time slots to conduct inter/intra frequency measurements on communication channel 18 for the purpose of determining whether second network entity 15 is a suitable handover/reselection candidate, or for conducting actual handover/reselection. For instance, each TD-SCDMA frame includes one or more TS0 and/or Special (“S”) slots during which UE 12 may make measurements in its currently operating technology. For example, in TD-SCDMA, base stations such as network entities 14 and 15 are configured to broadcast pilot signals during the TS0 slot, and so UE 12 can make TD-SCMA measurements in the operating frequency or in different TD-SCDMA frequencies during this slot.

In some aspects, UE 12 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. Additionally, first network entity 14 and second network entity 15 may each be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12. Further, first network entity 14 and second network entity 15 may be different cells located at the same network entity.

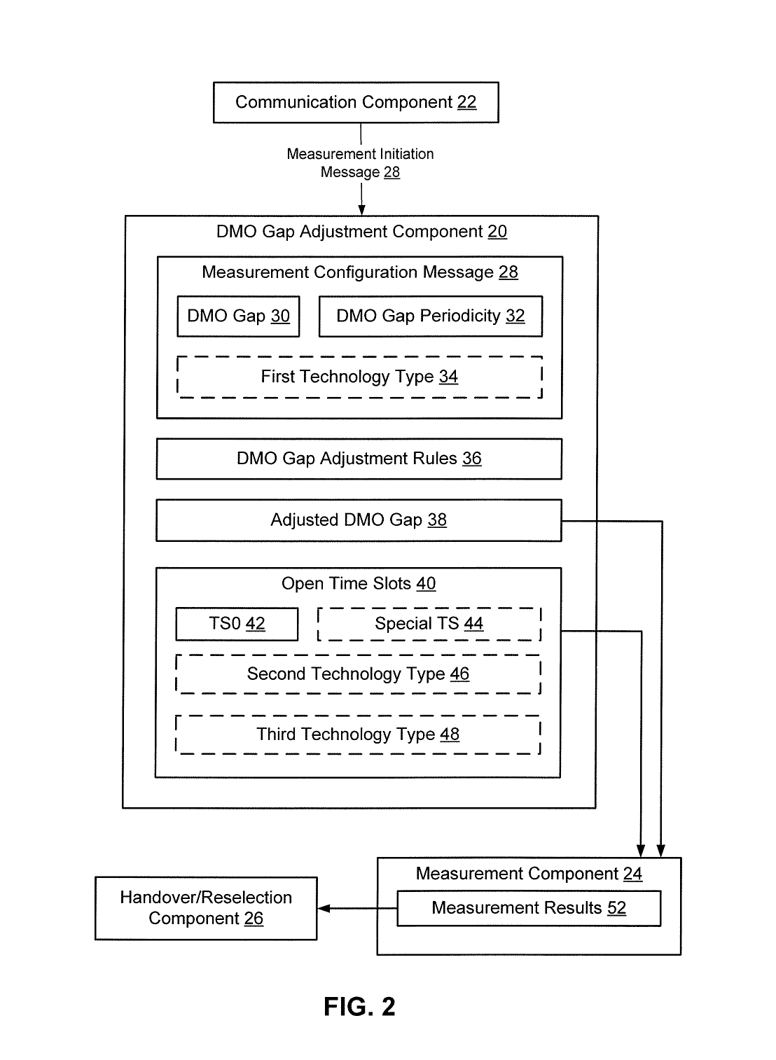

According to the present aspects, UE 12 may include DMO gap adjustment component 20, which may be configured to provide efficient frequency measurement allocation for one or more technology types, thereby enhancing handover and/or reselection procedures. For example, DMO gap adjustment component 20 may be configured to determine at least an adjusted DMO gap 38, based on communication received from the communication component 22, and to provide the adjusted DMO gap 38 to the measurement component 24 for subsequent measurement (e.g., IRAT measurements). For instance, adjusted DMO gap 38 is allocated across fewer time slots than a network-specified DMO gap, thereby making available one or more of the time slots during the network-specified DMO gap for performing other measurements. Further, based on the improved frequency measurement allocation determined by DMO gap adjustment component 20, handover/reselection component 26 may receive handover/reselection frequency related information, as measured by communication component 22, in order to maintain a continuous active/connected state and prevent service disconnection. It should be understood that DMO gap adjustment component 20 may conduct one or more procedures to enhance or efficiently allocate frequency measurements of designated frame durations in active/connected state or idle state. Further aspects of DMO gap adjustment component 20 are described herein with respect to FIG. 2.

In additional aspects, communication component 22 may be configured to transmit and receive wireless communications (e.g., one or more frames 19) with one or more network entities (e.g., first network entity 14). For example, in an aspect, the communication component 22 may transmit and/or receive data or information on or during one or more frames 19 from one or more network entities (e.g., first network entity 14). In some aspects, communication component 22 may provide or otherwise automatically transmit data or information received from network 16 to any one or more of various components and/or subcomponents of UE 12 (e.g., DMO gap adjustment component 20). Further, communication on the one or more communication channels (e.g., communication channels 17 and 18) may be conducted using time slots (e.g., time division multiplexing). Additionally, communication component 22 may include, but is not limited to, one or more of a transmitter, a receiver, a transceiver, protocol stacks, transmit chain components, and receive chain components.

Further, measurement component 24 may be configured to conduct inter/intra frequency measurements for signals from network entities operating according to one or more technology types on at least one frequency for enhanced cell reselection/handover. In such aspects, measurement component 24 may receive or otherwise obtain scheduling information (e.g., adjusted DMO gap 38) for the purpose of facilitating frequency searching in one or more modes (e.g., connected and/or idle), and for subsequent forwarding of the measurement results to handover/reselection component 26. Further, in such aspects, DMO gap adjustment component 20 may transmit or communicate adjusted DMO gap 38 to measurement component 24, where adjusted DMO gap 38 includes (directly or indirectly) scheduling information relating to open time slots, thereby enabling measurement component 24 to conduct one or more searches different from the IRAT measurement typically associated with the network-specified DMO gap. Upon locating one or more suitable handover candidates for handover/reselection in the designated technology type (e.g., TD-SCDMA), based on the measurements made in the open time slots created by adjusted DMO gap, measurement component 24 may transmit or provide the measurement results (e.g., one or more suitable frequencies and/or cell identifiers) to handover/reselection component 26.

Moreover, in an optional aspect, reselection/handover component 26, which may be configured to conduct cell handover/reselection based on the one or more frequencies (e.g., TD-SCDMA frequency) received or otherwise obtained from measurement component 24. For instance, reselection/handover component 26 may handover and/or reselect to a suitable cell (e.g., second network entity 15) based on the measurement results received or obtained from measurement component 24. Further, in some aspects, handover/reselection component 26 may include measurement component 24.

Referring to FIG. 2, an aspect of the DMO gap adjustment component 20 of UE 12 may include various components and/or subcomponents, which may be configured to provide enhanced frequency measurement allocation for one or more technology types in order to improve handover/reselection. For example, DMO gap adjustment component 20 may receive or otherwise obtain measurement configuration message 28 from the network 16 (FIG. 1), via, first network entity 14 (FIG. 1). In some aspects, measurement configuration message 28 may include a network-specified DMO gap 30, a network-specified DMO gap periodicity 32, and optionally an indication of a first technology type 34 for which searching and measurements are to be conducted during the DMO gap 30.

Specifically, in such aspects, DMO gap 30 enables or otherwise may be used to control UE measurement activities on inter-frequency or IRAT cells while UE 12 (FIG. 1), for instance, is in an active/connected state. That is, DMO gap 30 may include a network-specified IRAT measurement duration for a first technology type 34. DMO gap 30 or network-specified IRAT measurement duration may be any network-determined measurement time period during operation according to second technology type 46 in which UE 12 may switch communication resources, e.g., communication component 22, to permit IRAT measurements of first technology type 34. As an example, DMO gap 30 may be any network-specified duration defined in a unit of time (e.g., seconds, milliseconds, etc.). As such, during operation according to second technology type 46 (e.g., TD-SCDMA), measurement component 24 may execute DMO gap 30 to conduct IRAT measurements on or for first technology type 34 (e.g., LTE). Additionally, DMO gap periodicity 32 may configure a DMO gap occurrence (e.g., frequency or DMO gaps) at a network-specified interval. For instance, as an example, DMO gap periodicity 32 may be any network-specified duration defined in a unit of time (e.g., seconds, milliseconds, etc.)

Further, DMO gap adjustment component 20 may include one or more DMO gap adjustment rules 36, which may be executed by DMO gap adjustment component 20 to shorten DMO gap 30 and define adjusted DMO gap 38 to enable other measurements. For example, in an aspect, the one or more DMO gap adjustment rules 36 may be configured to adjust DMO gap 30 based on a predetermined knowledge that the duration of DMO gap 30 may not be used in its entirety for IRAT measurements for the first technology type 34, in combination with predetermined knowledge of where relevant time slots, such as TS0 and Special time slots, are located in a frame. In other words, DMO gap 30 may include or otherwise contain available time slots (e.g., open time slots 40) that may be used or allocated for measurements for other technology types (instead of first technology type 34) without experiencing degradations in IRAT measurement quality for the first technology type 34.

Accordingly, in order to enhance the measurement allocation for UE 12 during a given DMO gap 30, DMO gap adjustment component 20 may be configured to determine adjusted DMO gap 38 based on at least one DMO gap adjustment rule 36. For example, adjusted DMO gap 38 may be have its start position at some time slot subsequent to the start position of DMO gap 30. That is, DMO gap adjustment component 20 may determine adjusted DMO gap 38 for the purpose of at least opening or making available time slots for measurements in at least another technology type, e.g., TS0 and/or Special time slots for TD-SCDMA. Additionally, in some aspects, adjusted DMO gap 38 may be shorter in duration than DMO gap 30. For example, adjusted DMO gap 38 may be truncated in that one or both of the start time and end time may be different from that of DMO gap 30. Moreover, rather than being a single, continuous time period, adjusted DMO gap 38 may include a plurality of adjusted DMO gaps 38 within DMO gap 30, e.g., leaving open TS0 and/or Special time slots for TD-SCDMA measurements. In some aspects, DMO gap 30 may be dynamically adjusted to determine adjusted DMO gap 38 based on how long the first technology type (e.g., LTE) needs to complete or conduct measurements.

As a non-limiting example, DMO gap adjustment component 20 executing DMO gap adjustment rule 36 may transform DMO gap 30 having a 10 ms time period, such as by truncating or adjusting the time period to 7 ms, in order to define adjusted DMO gap 38. Additionally the start time or position may be shifted by, for instance, 3 ms. As such, the time slots (e.g., TS0 and/or Special time slot) that were originally scheduled or intended for IRAT measurements of the first technology type (e.g., LTE) may be assigned or allocated to perform frequency measurements (e.g., intra-frequency measurements) of another technology type (e.g., TD-SCDMA) to facilitate handover/reselection. Further, the foregoing adjustments may be based on one or more DMO gap adjustment rules 36. For example, DMO gap adjustment rules 36 may include one or more rules that control the adjustment of DMO gap 30 by DMO gap adjustment component 20. In an aspect, DMO gap adjustment rules 36 may shift an initiation of the IRAT measurement of the first technology type 34 by at least one time slot. In other aspects, DMO gap adjustment rules 36 trigger an adjustment of DMO gap 30 based on one or more triggering parameters, such as, but not limited to, receipt of measurement configuration message 28 and low signal strength or quality of serving cell (e.g., first network entity 14, FIG. 1).

Moreover, DMO gap adjustment component 20 may be configured to determine one or more open time slots 40. For instance, DMO gap adjustment component 20 may determine one or more open time slots 40 using DMO gap adjustment rules 36 and/or adjusted DMO gap 38. That is, upon determining adjusted DMO gap 38, DMO gap adjustment component 20 may determine or otherwise detect one or more open time slots 40. In such aspects, open time slots 40 may be one or both of TS0 42 and optionally special time slots 44. The open time slots 40 may optionally be made available to the second technology type 46, which may configure to instruct measurement component 24 to perform inter/intra frequency measurements on, for example, TD-SCDMA. In other aspects, open time slots 40 may be available time slots following IRAT measurements of the first technology type 34. In such cases, open time slots 40 may optionally be made available to the third technology type 48, which may configure or instruct measurement component 24 to perform inter/intra frequency measurements on, for example, GSM.

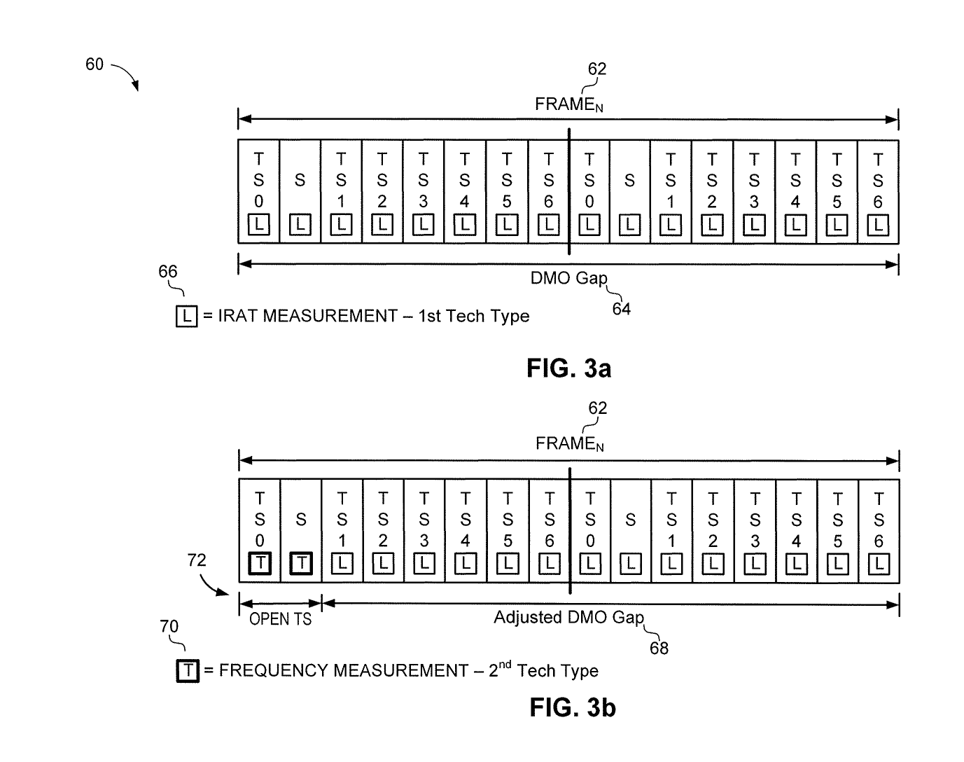

Referring to FIG. 3a, in an aspect, an example diagram of a measurement allocation scheme for a single frame DMO gap 64, which may be the same as DMO gap 30 described above, is illustrated. In this example, Frame_{N} 62 may be a single frame of 10 ms duration. Further, every frame may include two subframes each having time slots TS0 to TS6. As described herein, TS0 may typically be designated for inter/intra frequency measurements for a particular technology type (e.g., TD-SCDMA). However, the network-specified DMO gap 64 for IRAT measurement 66 on a different technology type (e.g., LTE) may prevent inter/intra frequency measurements for the particular technology type. As such, during an active/connected state, a UE (e.g., UE 12, FIG. 1) may require handover/reselection, yet may be unable to perform one or more inter/intra frequency measurements on the particular technology type, resulting in network disconnection and/or call drop.

Referring to FIG. 3b, in another aspect, illustrates an example diagram of an enhanced measurement allocation scheme using DMO gap adjustment component 20 (FIGS. 1 and 2) for a single frame 62. Specifically, DMO gap adjustment component 20 (FIGS. 1 and 2) may determine adjusted DMO gap 68, which may be the same as adjusted DMO gap 38 described above, for Frame_{N} 62, which results in open time slots 72. As such, open time slots 72, which may be the same as open time slots 40 described above, may be used for inter/intra frequency measurements 70 for a particular technology type that may be the current operating technology type (e.g., TD-SCDMA). Accordingly, in this example, during an active/connected state, a UE (e.g., UE 12, FIG. 1) may be able to perform one or more inter/intra frequency measurements on the particular technology type, and perform handover/reselection to a suitable cell for service continuity.

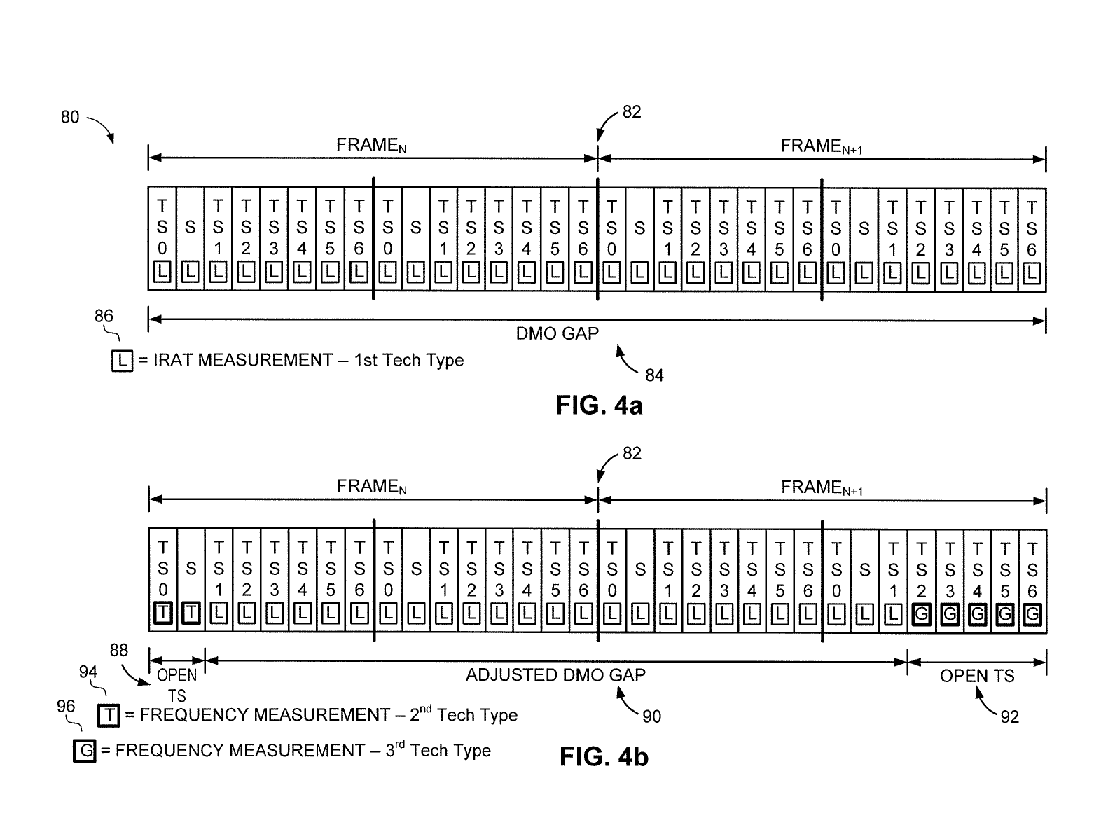

Referring to FIG. 4a, in an aspect, an example diagram of a measurement allocation scheme for a dual frame 82 DMO gap 84, which may be the same as DMO gap 30 described above, is illustrated. In this example, Frame_{N} and Frame_{N+1} may be a dual frame 82 of 20 ms duration. Further, every frame may include two subframes each having time slots TS0 to TS6. As described herein, TS0 may typically be designated for inter/intra frequency measurements for a particular technology type (e.g., TD-SCDMA). However, the network-specified DMO gap 84 for IRAT measurement 86 on a different technology type (e.g., LTE) may prevent inter/intra frequency measurements for the particular technology type on, for instance, TS0. As such, during an active/connected state, a UE (e.g., UE 12, FIG. 1) may require handover/reselection, yet may be unable to perform one or more inter/intra frequency measurements on the particular technology type, resulting in network disconnection and/or call drop.

Referring to FIG. 4b, in further aspects, illustrates an example diagram of an enhanced measurement allocation scheme using DMO gap adjustment component 20 (FIGS. 1 and 2) for a dual frame 82. Specifically, DMO gap adjustment component 20 (FIGS. 1 and 2) may determine adjusted DMO gap 90, which may be the same as adjusted DMO gap 38 described above, for Frame_{N} and Frame_{N+1}, which results in open time slots 88 and 92. Open time slots 88 and 92 may be the same as open time slots 40 described above. As such, open time slots 72 may be used for inter/intra frequency measurements 70 for a particular technology type that may be the current operating technology type (e.g., TD-SCDMA). Accordingly, in this example, during an active/connected state, a UE (e.g., UE 12, FIG. 1) may be able to perform one or more inter/intra frequency measurements on the particular technology type, and perform handover/reselection to a suitable cell for service continuity. Further, open time slots 92 may be used for IRAT measurements of a technology type that is different from the IRAT measurements of the adjusted DMO gap 90 and the open time slot 88 frequency measurements.

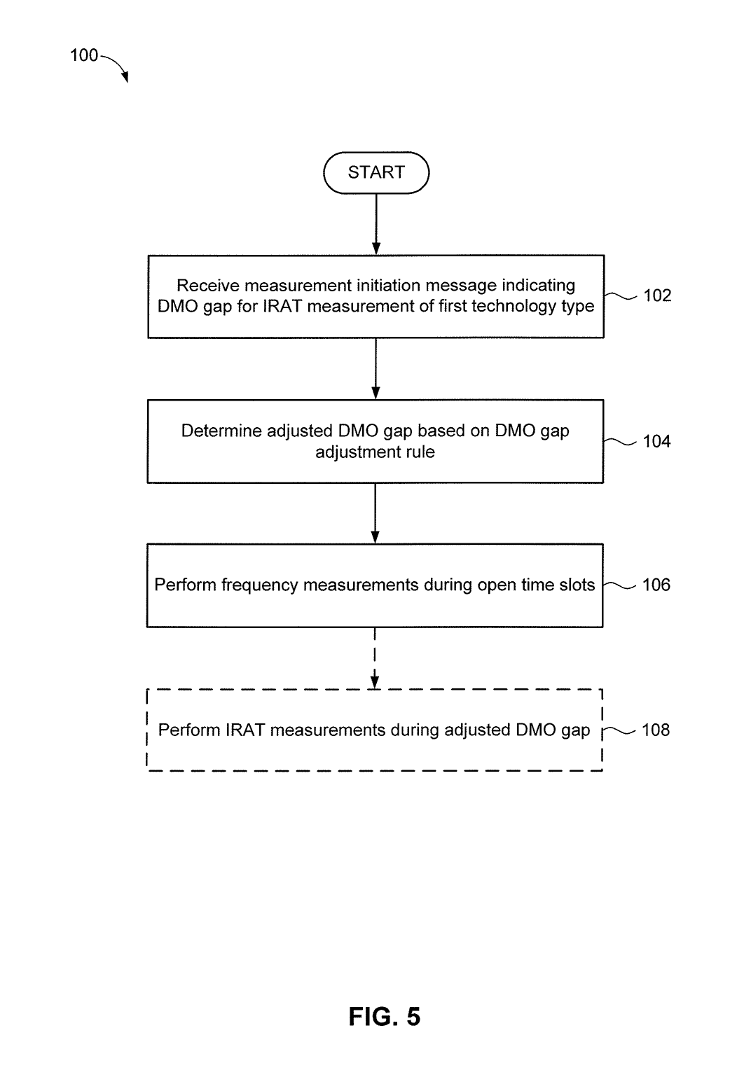

Referring to FIG. 5, in operation, a UE such as UE 12 (FIG. 1) may perform one aspect of a method 100 for enhancing frequency measurements. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 102, method 100 includes receiving a measurement configuration message indicating a DMO gap for an IRAT measurement of a first technology type. For example, as described herein, UE 12 may execute DMO gap adjustment component 20 (FIGS. 1 and 2) to receive or otherwise obtain a measurement configuration message 28 indicating a DMO gap 30 for an IRAT measurement of a first technology type 34 (e.g., LTE) from communication component 22. In other aspects, as described herein, UE 12 may execute communication component 22 (FIGS. 1 and 2) to receive the measurement configuration message 28 indicating a DMO gap 30 for an IRAT measurement of a first technology type from network entity 14. Further, in some aspects, the measurement configuration message 28 may include a DMO gap periodicity 32 that configures a DMO gap 30 and/or a corresponding adjusted DMO gap 38 occurrence at a network-specified interval. Additionally, the DMO gap 30 may include a network-specified IRAT measurement duration for the first technology type 34.

Moreover, at block 104, method 100 includes determining an adjusted DMO gap based on at least one DMO gap adjustment rule. For instance, as described herein, UE 12 may execute DMO gap adjustment component 20 (FIGS. 1 and 2) to determine an adjusted DMO gap 38 based on at least one DMO gap adjustment rule 36. In some aspects, the adjusted DMO gap 38 is shorter in duration that the DMO gap 30. Further, the one or more DMO gap adjustment rules 36 may shift an initiation or start point of the IRAT measurement of the first technology type 34 by at least one time slot (e.g., shift from TS0 to TS1).

In addition, at block 106, method 100 includes performing frequency measurements during open time slots. For example, as described herein, UE 12 may execute measurement component 24 (FIGS. 1 and 2) to obtain the measurement information (e.g., open time slots 40) from DMO gap adjustment component 20 and perform at least one frequency measurement during one or more open time slots 40 made available by the adjusted DMO gap 38 for a second technology type 46. In some aspects, the second technology type may be TD-SCDMA. Additionally, in such aspects, the one or more open time slots may be at least one of a TS0 42 and a special time slot 44. In other aspects, measurement component 24 (FIGS. 1 and 2) may obtain the measurement information (e.g., open time slots 40) from DMO gap adjustment component 20 and perform at least one frequency measurement during one or more open time slots 40 made available by the adjusted DMO gap 38 for a third technology type 48. In such aspects, the third technology type 48 may be GSM.

Further, at block 108, method 100 may optionally include performing IRAT measurements during the adjusted DMO gap. For instance, as described herein, UE 12 may execute measurement component 24 (FIGS. 1 and 2) to obtain the measurement information (e.g., adjusted DMO gap 38) from DMO gap adjustment component 20 and perform at least one frequency measurement during the adjusted DMO gap 38 for the first technology type 34. In some aspects, the first technology type 46 may be LTE.

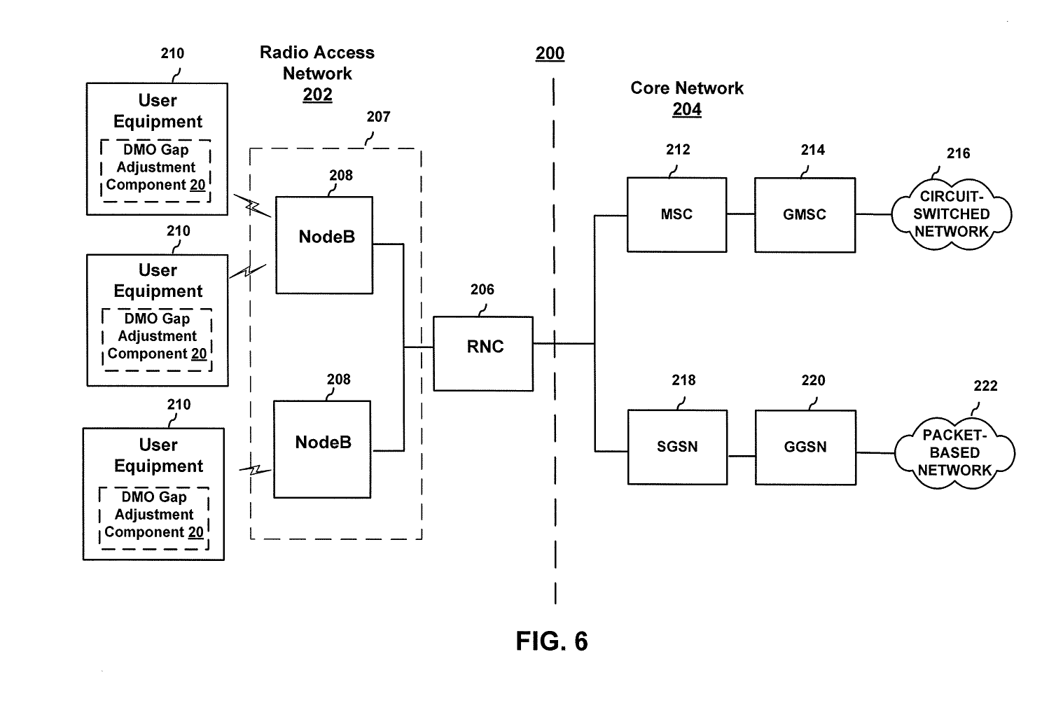

Turning now to FIG. 6, a block diagram is shown illustrating an example of a telecommunications system 200 in which UE 12 discussed herein, and/or its corresponding DMO gap adjustment component 20, may operate, such as in the form of or as a part of UEs 210. The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services. The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown, each of which may be the same as or similar to one of first network entity 14 second network entity (FIG. 1); however, the RNS 207 may include any number of wireless Node Bs.

The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208, each of which may include DMO gap adjustment component 20 of UE 12 (FIG. 1). The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

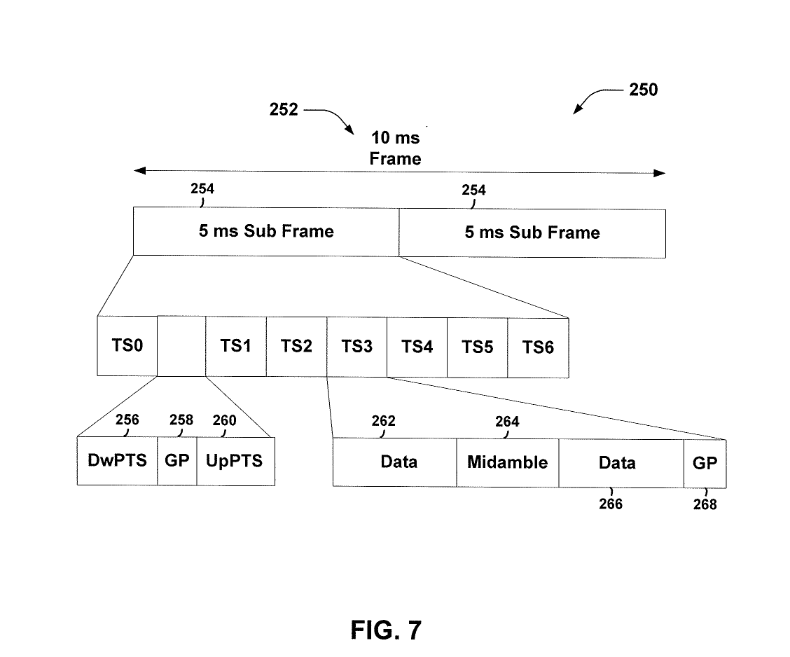

FIG. 7 shows a frame structure 250 for a TD-SCDMA carrier, which may be used in communications between UE 12 and one or both of first network entity 14 and second network entity 15 discussed herein. The TD-SCDMA carrier, as illustrated, has a frame 252 that may be 10 ms in length. The frame 252 may have two 5 ms subframes 254, and each of the subframes 254 includes seven time slots, TS0 through TS6. The first time slot, TS0, may be allocated for inter/intra frequency measurements and/or downlink communication, while the second time slot, TS1, may be allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 256, a guard period (GP) 258, and an uplink pilot time slot (UpPTS) 260 (also known as the uplink pilot channel (UpPCH)) are located between TS0 and TS1, and may optionally be referred to as a special time slot. Each time slot, TS0-TS6, may allow data transmission multiplexed on a maximum of, for instance, 16 code channels. Data transmission on a code channel includes two data portions 262 separated by a midamble 264 and followed by a guard period (GP) 268. The midamble 264 may be used for features, such as channel estimation, while the GP 268 may be used to avoid inter-burst interference.

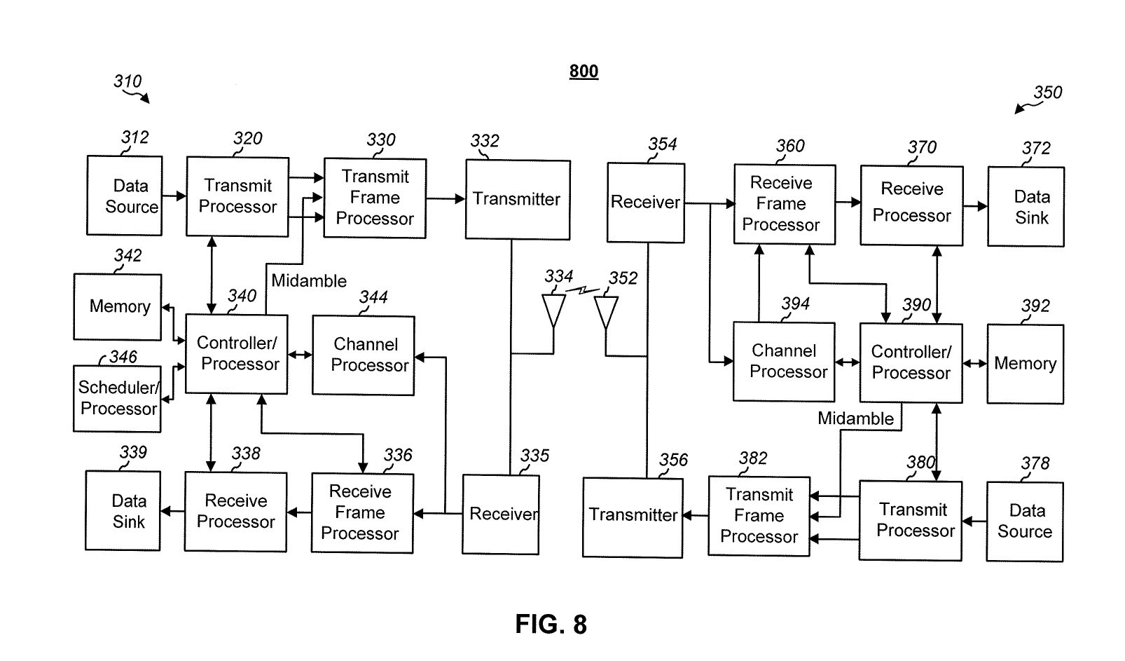

FIG. 8 is a block diagram of a Node B 310 in communication with a UE 350 in a RAN 300, where RAN 300 may be the same as or similar to RAN 202 in FIG. 6, the Node B 310 may be the same as or similar to Node B 208 in FIG. 6 or the network entity 14 in FIG. 1, and the UE 350 may be the same as or similar to UE 210 in FIG. 6 or the UE 12 in FIG. 1 including DMO gap adjustment component 20. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 6) from the UE 350. The symbols generated by the transmit processor 320 are provided to a transmit frame processor 330 to create a frame structure. The transmit frame processor 330 creates this frame structure by multiplexing the symbols with a midamble 214 (FIG. 6) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 6) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 6) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 6) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §212, sixth paragraph, unless the element is expressly recited using the phrase “means for” or, in the case of a method claim, the element is recited using the phrase “step for.”

What is claimed is:

1. A method of operating a user equipment (UE) for wireless communication, comprising:
receiving a measurement configuration message indicating a Dedicated Channel (DCH) measurement occasion (DMO) gap for inter-radio access technology (IRAT) measurements of a first technology type during operation of the UE according to a second technology type;
determining an adjusted DMO gap based on at least one DMO gap adjustment rule, wherein the adjusted DMO gap is shorter in duration than the DMO gap; and
performing a frequency measurement for the second technology type during the DMO gap in one or more open time slots made available by the adjusted DMO gap.

2. The method of claim 1, wherein the at least one DMO gap adjustment rule shifts an initiation of the IRAT measurement for the first technology type by at least one time slot.

3. The method of claim 1, wherein the one or more open time slots comprise at least one of a time slot zero (TS0) and a Special time slot.

4. The method of claim 1, wherein the second technology type comprises a time division synchronous code division multiple access (TD-SCDMA) technology type.

5. The method of claim 4, wherein the operation of the UE according to the second technology type comprises operation according to a TD-SCDMA connected mode.

6. The method of claim 1, further comprising performing an IRAT measurement during the adjusted DMO gap for the first technology type.

7. The method of claim 6, wherein the first technology type comprises a long term evolution (LTE) technology type.

8. The method of claim 1, wherein the one or more open time slots comprise time slots associated with the DMO gap following the adjusted DMO gap.

9. The method of claim 8, further comprising performing an IRAT measurement for a third technology type during the one or more open time slots.

10. The method of claim 9, wherein the third technology type comprises a global system for mobile communications (GSM) technology type.

11. The method of claim 1, wherein the measurement configuration message comprises a DMO gap periodicity indication that configures a DMO gap occurrence at a network-specified interval; and
wherein the DMO gap comprises a network-specified IRAT measurement duration for the first technology type.

12. A computer program product for wireless communication, comprising:
a computer-readable medium including:
at least one instruction for causing a computer to receive a measurement configuration message indicating a Dedicated Channel (DCH) measurement occasion (DMO) gap for inter-radio access technology (IRAT) measurements of a first technology type during operation of a user equipment (UE) according to a second technology type;
at least one instruction for causing a computer to determine an adjusted DMO gap based on at least one DMO gap adjustment rule, wherein the adjusted DMO gap is shorter in duration than the DMO gap; and
at least one instruction for causing a computer to perform a frequency measurement for the second technology type during the DMO gap in one or more open time slots made available by the adjusted DMO gap.

13. An apparatus for wireless communication, comprising:
means for receiving a measurement configuration message indicating a Dedicated Channel (DCH) measurement occasion (DMO) gap for inter-radio access technology (IRAT) measurements of a first technology type during operation of a user equipment (UE) according to a second technology type;
means for determining an adjusted DMO gap based on at least one DMO gap adjustment rule, wherein the adjusted DMO gap is shorter in duration than the DMO gap; and
means for performing a frequency measurement for the second technology type during the DMO gap in one or more open time slots made available by the adjusted DMO gap.

14. A user equipment (UE) apparatus for wireless communication, comprising:
a memory storing executable instructions;
and a processor in communication with the memory, wherein the processor is configured to execute the instructions to:
receive a measurement configuration message indicating a Dedicated Channel (DCH) measurement occasion (DMO) gap for inter-radio access technology (IRAT) measurements of a first technology type during operation of the UE according to a second technology type;
determine an adjusted DMO gap based on at least one DMO gap adjustment rule, wherein the adjusted DMO gap is shorter in duration than the DMO gap; and
perform a frequency measurement for the second technology type during the DMO gap in one or more open time slots made available by the adjusted DMO gap.

15. The apparatus of claim 14, wherein the at least one DMO gap adjustment rule shifts an initiation of the IRAT measurement for the first technology type by at least one time slot.

16. The apparatus of claim 14, wherein the one or more open time slots comprise at least one of a time slot zero (TS0) and a Special time slot.

17. The apparatus of claim 14, wherein the second technology type comprises a time division synchronous code division multiple access (TD-SCDMA) technology type.

18. The apparatus of claim 17, wherein the operation of the UE according to the second technology type comprises operation according to a TD-SCDMA connected mode.

19. The apparatus of claim 14, wherein the processor is further configured to execute the instructions to perform an IRAT measurement during the adjusted DMO gap for the first technology type.

20. The apparatus of claim 19, wherein the first technology type comprises a long term evolution (LTE) technology type.

21. The apparatus of claim 14, wherein the one or more open time slots comprise time slots associated with the DMO gap following the adjusted DMO gap.

22. The apparatus of claim 21, wherein the processor is configured to execute the instructions to perform an IRAT measurement for a third technology type during the one or more open time slots.

23. The apparatus of claim 22, wherein the third technology type comprises a global system for mobile communications (GSM) technology type.

24. The apparatus of claim 14, wherein the measurement configuration message comprises a DMO gap periodicity indication that configures a DMO gap occurrence at a network-specified interval; and
wherein the DMO gap comprises a network-specified IRAT measurement duration for the first technology type.
